(19) United States
(12) Patent Application Publication
(10) Pub. No.: US 2011/0266471 A1
(43) Pub. Date: Nov. 3, 2011

(54) PILOTED MIDDLE-HIGH PRESSURE GATE VALVE

(76) Inventor: Zuoyi Wang, Guangdong (CN)

(21) Appl. No.: 12/601,528

(22) PCT Filed: Mar. 16, 2008
(86) PCT No.: PCT/CN08/70509

§ 371 Date: Jul. 14, 2011

(30) Foreign Application Priority Data
May 24, 2007 (CN) 200720116291.6

(51) Int. Cl. F16K 31/12

(52) U.S. Cl. 251/25

(57) ABSTRACT

A piloted middle-high pressure gate valve includes a valve stem (4) connecting with a gate plate (9) and a valve body (5). A pilot unloading valve (6) is installed under said valve stem (4), under which is said gate plate (9) that has a balancing chamber (14) therein. A valve core (8) provided in said balancing chamber (14) is between said valve (5) and a back pressure spring (7) and has a damping hole (13) for communicating a valve inlet with said balancing chamber (14). Such a gate valve is adapted for on-off control of a middle high pressure fluid.

### FIELD OF THE INVENTION

The present invention relates to a gate valve which has a pilot valve therein for usage under middle or high pressure.

### DESCRIPTION OF PRIOR ART

A gate valve is a device which opens/seals the path of the fluid by a wedge or a parallel shape valve plate. A gate valve is usually designed to be fully opened and closed and since its moving direction is perpendicular to the fluid current, thus when the pressure inside the gate valve is too high, operating a gate valve becomes a difficult task. Besides the extra strength needed for lifting and lowering the valve plate, high pressure constantly damages the sealing surface, causing the leakage or cavitation of the gate valve and reducing the utility life thereof. Some methods have been disclosed such as applying a coating of high hardness on the surface of the valve plate or valve stem. However, said defect was not solved effectively.

### SUMMARY OF THE INVENTION

The present invention relates to a piloted gate valve for middle and high pressure service, utilizing a pilot valve driving another valve to unload and reduce the pressure applied to the valve plate and valve stem, reducing the wear and cavitation to the valve plate, extending the service life thereof.

A piloted middle-high pressure gate valve consists essentially of a valve stem, connected to a gate plate and a valve body. A pilot unloading valve is provided under said valve stem, under which is said gate plate that has a balancing chamber therein. A valve core provided at inside of the balancing chamber is disposed between said valve body and a back pressure spring. Said valve core includes a damping hole for connecting a valve inlet with the balancing chamber.

Further, the sealing surface of said valve core is selected from a spherical surface, a tapered surface or a flat surface.

Moreover, said pilot unloading valve comprises of a pilot unloading valve core and a pilot unloading back pressure spring; a distal end of said pilot unloading back pressure spring is attached to said valve stem.

Moreover, the bottom side of the valve body includes a stop for corresponding to the valve plate and/or a chute is provided on the valve plate or on the pilot unloading valve.

### COMPARISON WITH PRIOR ART

1. When valve stem (4) is moving upwardly, pressure applied to the back pressure spring (7) is relieved. When the pressure of pilot unloading valve (6) is lower than the of valve inlet, the pilot unloading valve (6) initiates the overflow causing the valve core (8) to open and discharge the pressure within the balancing chamber (14). The higher pressure from the valve inlet pushes the valve core (8) backward, thus the valve core (8) and valve plate (9) can be easily lifted to open the valve completely.

2. When valve stem (4) is moving downwardly, gate plate (9) is driven until contacting with the stop (11). The force provided by turning the valve stem (4) drives the pilot backpressure spring to seal the pilot unloading valve (6). The pressurized fluid flows into the balancing chamber (14) by passing through the damping hole (13). Under effect of pressure from the fluid and backpressure spring (7), the valve plate (9) moves slightly along a slide toward the valve outlet, opposed to the moving direction of valve core (8). Both movements of valve plate (9) and valve core (8) block the fluid passage completely. For valve with no slide provided, the position of the valve plate (9) can be limited by the stop (11).

3. By driving the pilot unloading valve (6), the valve plate (9) can maintain in a balancing state, reducing the possible wear caused by pressure differential.

### BRIEF DESCRIPTION OF DRAWING

FIG. 1 is a schematic view of the present invention.

### DETAILED DESCRIPTION OF THE PREFERRED EMBODIMENTS

The preferred embodiments of the present invention are described in details according to appended drawing hereinafter.

### First Embodiment

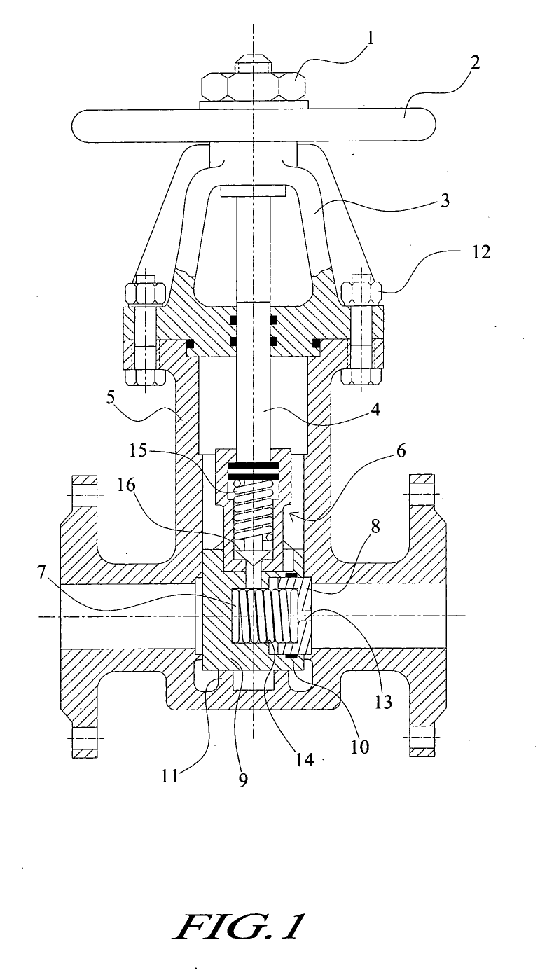

A piloted middle-high pressure gate valve as shown in FIG. 1, consists essentially of a valve stem (4), connected to a gate plate (9) and a valve body (5). A pilot unloading valve (6) is provided under said valve stem (4), under which is said gate plate (9) that includes a balancing chamber (14) therein. A valve core (8) provided at inside of the balancing chamber (14) is disposed between said valve body (5) and a back pressure spring (7). Said valve core (8) includes a damping hole (13) for connecting a valve inlet with the balancing chamber (14).

### Second Embodiment

Said piloted middle-high pressure gate valve as disclosed in the first embodiment, the sealing surface of the valve core (8) can further be provided with a spherical, a tapered or a flat surface.

### Third Embodiment:

Said piloted middle-high pressure gate valve as disclosed in the first or second embodiment, the pilot unloading valve (6) includes a pilot unloading valve core and a pilot back pressure spring. A side of the pilot back pressure spring is attached to the valve stem (4).

### Fourth Embodiment:

Said piloted middle-high pressure gate valve as disclosed in the first, second or third embodiment, a stop (11) for accommodating the valve plate (9) is provided on a bottom of the valve body (5).

Moreover, a slide is provided at where the valve plate (9) engages with the valve (6) or at where the pilot unloading valve (6) engages with the valve stem (4). The slide can ensure that said valve plate (9) or pilot unloading valve (6) to move opposite to the movement of the valve stem (4), preventing the valve stem (4) to be bent by the pressure difference.

### Fifth Embodiment:

A piloted middle-high pressure gate valve comprises of a valve body (5), consisted of a nut (1), a handwheel (2) and a gland (3), a valve stem (4) connected therewith, a pilot unloading valve provided under said valve stem (4), under which is a gate plate (9), a valve core (8) provided between a backpressure spring (7) and the valve body (5), seal gasket (10), and bolt (12) for attaching the gland (3) with the valve body (5). A damping hole (13) is disposed at the valve core (8), and a stop (11) is provided at a bottom side of the valve body (5). Said handwheel (2) is engaged with the gland (3) by the nut (1) and said valve stem (4) is attached with the handwheel (2). A bottom side of said valve stem (4) is attached to a pilot unloading valve (6) and said valve plate (9) respectively. Said valve plate (9) includes a balancing chamber (14) therein and a backpressure spring is provided within the chamber (14).

1. A piloted middle-high pressure gate valve consists essentially of a valve stem, connected to a gate plate and a valve body; said piloted middle-high pressure gate valve is characterized in that a pilot unloading valve is provided under said valve stem, under which is said gate plate(9) that has a balancing chamber(14) therein;
A valve core provided at inside of the balancing chamber is disposed between said valve body and a back pressure spring; said valve core includes a damping hole for connecting a valve inlet with the balancing chamber.

2. A piloted middle-high pressure gate valve of claim 1, wherein a sealing surface of the valve core is selected from a spherical surface, a tapered surface or a flat surface.

3. A piloted middle-high pressure gate valve of claim 1, wherein said pilot unloading valve comprises of a pilot unloading valve core and a pilot unloading back pressure spring; a distal end of said pilot unloading back pressure spring is attached to said valve stem.

4. A piloted middle-high pressure gate valve of claim 2, wherein said pilot unloading valve comprises of a pilot unloading valve core and a pilot unloading back pressure spring; a distal end of said pilot unloading back pressure spring; a distal end of said pilot unloading back pressure spring is attached to said valve stem.

5. (canceled)

6. A piloted middle-high pressure gate valve of claim 1, wherein a bottom side of the valve body includes a stop for corresponding the valve plate and/or a chute is provided on the valve plate or on the pilot unloading valve.

7. A piloted middle-high pressure gate valve of claim 2, wherein a bottom side of the valve body includes a stop for corresponding the valve plate and/or a chute is provided on the valve plate or on the pilot unloading valve.

8. A piloted middle-high pressure gate valve of claim 3, wherein a bottom side of the valve body includes a stop for corresponding the valve plate and/or a chute is provided on the valve plate or on the pilot unloading valve.
